(19) United States
(12) Patent Application Publication
(10) Pub. No.: US 2005/0055763 A1
(43) Pub. Date: Mar. 17, 2005

(54) Hollow decorative fastener for openings defined in shell of bathtub provided with an air massage system

(76) Inventor: Miguel Castellote, Sainte-Marguerite-de-Dorchester (CA)

Correspondence Address: OGILVY RENAULT, 1981 MCGILL COLLEGE AVENUE, SUITE 1600, MONTREAL, QC, H3A2Y3, CA

(21) Appl. No.: 10/694,911

(22) Filed: Oct. 29, 2003

Related U.S. Application Data
(60) Provisional application No. 60/422,120, filed on Oct. 30, 2002.

(30) Foreign Application Priority Data
Oct. 29, 2002 (CA) 2,410,110

(51) Int. Cl. A61H 33/04

(52) U.S. Cl. 4/541.6

(57) ABSTRACT

A fastener for use in air massage systems used with a bathtub that includes a shell having at least two layers with at least one hole being defined through the shell. The fastener, for instance in the form of a rivet, comprises a hollow body adapted to extend through the hole in the shell and a securing mechanism provided for anchoring the fastener in the hole and for retaining together the layers of the shell. The securing mechanism can comprise enlarged distal and proximal elements provided at opposed ends of the hollow body and adapted to be disposed against inner visible and outer hidden surfaces of the shell. The proximal element includes a decorative head adapted to at least partly overlie the visible surface of the shell.

This application claims priority on Canadian Patent Application No. 2,410,110, filed on Oct. 29, 2002 by the present applicant, and on U.S. provisional Patent Application No. 60/422,120, filed on Oct. 30, 2002 by the present applicant.

### BACKGROUND OF THE INVENTION

1. Field of the Invention

The present invention relates to bathtub air massage systems and, more particularly, to such systems having hidden air jets and/or channel-type air delivery means.

2. Description of the Prior Art

The Channel system, e.g. as in the Ultra™ bathtub, consists in surrounding a bathtub with a fibreglass air cavity. Thirty to ninety holes of more or less ⅛″ in diameter are defined through the bathtub. Air is propelled in the cavity by a blower and then escapes through each hole to create turbulence in the water.

Also known from Canadian Application No. 2,356,494 (in the name of C.G. Air Systemes Inc.) is an air massage system wherein upstream of the holes defined in the shell of the bathtub (i.e. behind this shell), hidden air jets are provided to deliver pressurised air through the holes and into the bathtub's cavity. These air jets are connected to a blower via tubing that is also hidden.

Such holes defined in the shell of the bathtub may define slightly sharp edges and are not necessarily very aesthetic.

### SUMMARY OF THE INVENTION

It is therefore an aim of the present invention to provide a decorative member for lining holes defined in the shell of a bathtub provided with an air massage system.

It is also an aim of the present invention to provide such a decorative member that also acts as a fastener to hold together the various layers forming the shell.

It is a further aim of the present invention to provide a tool for installing the decorative member to the shell.

It is a still further aim of the present invention to provide a method for installing the decorative member to the shell.

Therefore, in accordance with the present invention, there is provided a fastener for use in air massage systems used with a bathtub having a shell having at least two layers, at least one hole being defined through the shell, comprising a hollow body adapted to extend through said hole and securing means provided for anchoring said fastener in the hole and for retaining together the layers of the shell.

Also in accordance with the present invention, there is provided a decorative device for use in air massage systems used with a bathtub having a shell and at least one hole defined through the shell, comprising a hollow body adapted to extend through said hole and a decorative member provided at a visible end of the decorative device and defining an opening in fluid communication with said hollow body such that pressurised air provided by the air massage system is conveyed through said decorative device and into the bathtub.

Further in accordance with the present invention, there is provided a fastener in combination with a bathtub provided with an air massage system, said bathtub comprising a shell defining a bathing cavity and having at least two juxtaposed layers defining opposed visible and hidden surfaces of said shell, a plurality of holes being defined through said shell such that pressurised air delivered by said air massage system is conveyed through said holes from said hidden surface to said visible surface and into said cavity, said fastener being provided for each of said holes and comprising a hollow body extending through said hole and securing means provided for anchoring said fastener in said hole and for retaining together said layers of said shell.

Still further in accordance with the present invention, there is provided a method of installing a fastener into a hole of a shell of a bathtub provided with an air massage system, comprising the steps of: (a) providing a hollow fastener; (b) positioning said fastener on a tool; (c) inserting said tool and said fastener carried thereby in said hole via a first direction; (d) displacing said tool in a second direction different than said first direction such that said tool deforms said fastener and secures said fastener to said hole; and (e) removing said tool from said hole.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a vertical cross-sectional view of a bottom corner section of a bathtub provided with an air massage system and showing a hollow decorative fastener in accordance with the present invention;

FIG. 2 is a perspective view of the bathtub provided with the air massage system;

FIGS. 3a to 3d are cross-sectional views showing successive steps in the installation of the hollow decorative fastener into a hole defined in the shell of the bathtub, in accordance with a first embodiment of the present invention; and

FIGS. 4a to 4d are cross-sectional views showing successive steps in the installation of the hollow decorative fastener into a hole defined in the shell of the bathtub, in accordance with a second embodiment of the present invention.

### DESCRIPTION OF THE PREFERRED EMBODIMENTS

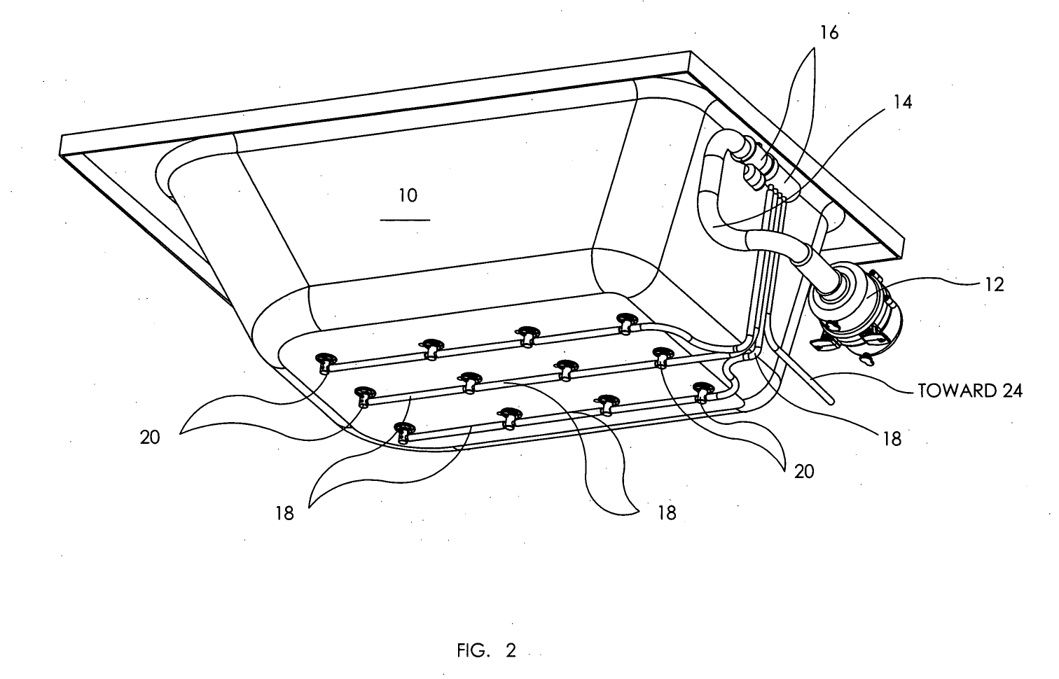

Referring to FIG. 2, a bathtub B is shown provided with an air massage system S. The bathtub B includes a shell 10 that defines an inner cavity within which water can be received in a well known manner.

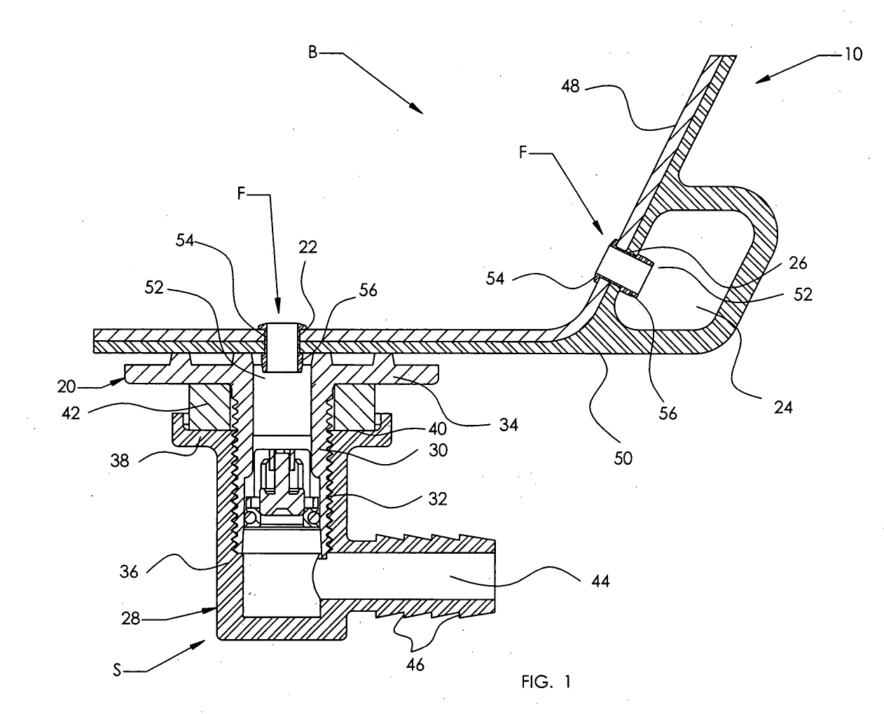

The air massage system S includes a blower 12 (which may enclose a heating element), a flexible or rigid main piping 14 connecting the blower 12 to a manifold 16, and a series of rigid or flexible branch pipes 18 that connect the manifold 16 to downstream air jets 20 that are concealingly mounted behind the shell 10. A number of holes 22 (FIG. 1) are defined through the shell 10 of the bathtub B with an air jet 20 being sealingly mounted to a hidden surface of the shell 10 of the bathtub B opposite each hole 22. The air massage system S may also include a sequencer and an electronic controller (not shown).

As seen in FIG. 1, a channel 24 can be provided on the sides of the bathtub B with air from the blower 12 being directed into the channel 24 and through further holes 26 defined in the shell 10 opposite the channel 24.

Each hidden air jet 20 is illustrated mounted against the hidden outer surface of the shell 10 of the bathtub B and to a fitting 28, such as an elbow (herein shown), a nipple or a Tee. The air jet 20 includes a jet body 30 that comprises an exteriorly threaded hollow tube 32 and an end flange 34. A unidirectional flow mechanism is provided within the hollow tube and can take the form of any water non-return device.

The elbow fitting 28 comprises an interiorly tapped hollow tube 36. A flange 38 is provided at a distal outlet of the tapped hollow tube 36. The flange 38 defines an annular groove 40 upon which rests an annular seal 42. A proximal inlet 44 of the fitting 28 extends laterally from the tapped hollow tube 36, and comprises a number of successive and parallel exterior annular wedges 46 for a sealed connection to a branch pipe 18.

Air is blown through the flexible branch pipe 18 and enters the hidden air jet 20 by the inlet 44. It fills the tapped hollow tube 36 and builds sufficient pressure to open and flow through the unidirectional flow mechanism. Then, it exits in the bathtub B through the holes 22 and creates a turbulence in the water filling the bathtub B.

Air blown into the channel 24 is conveyed through holes 26 defined along the channel 24 which extends peripherally around a bottom corner of the bathtub B. A variation of the Channel-type bathtub replaces the channel 24 by a cavity substantially extending along the hidden outer surface of the shell of the bathtub, thereby defining a plenum which in fact extends across the complete bottom of the bathtub and also possibly behind the side wall thereof. Similarly, the plenum conveys air through holes such as holes 26.

It is possible for air jets 20 to be mounted in the channel 24 or the plenum of the bathtub, in a bonded manner to the hidden outer surface of the shell 10 of the bathtub B, whereby it is possible to remove the flexible pipes 18 and the elbow fittings 28, with the hidden air jets 20 being simply fed with pressurised air contained in the channel 24 or plenum while still preventing the infiltration of bathtub water in the channel 24.

In all of the above embodiments, the air massaging system S is completely hidden by way of the use of the air jets 20 (and channel 24), which only leaves the holes 22 (and 26) of this air massaging system S to be visible.

The unidirectional flow mechanism provided in the air jet 20 allows for the free release of air in the bathtub B. Once the air pressure in the flexible pipes 18 is reduced, upon the end of operation of the system S for example, the unidirectional flow mechanism closes, thereby preventing the bathtub water from entering in the flexible pipes 18 and so causing, e.g. by its stagnation, a contamination of the flexible pipes 18 and of the remaining piping network of the air massage system S. As air is the sole fluid in contact with the flexible pipes and with the piping network of the air massage system, the hidden air jet ensures a high hygiene level.

The unidirectional flow mechanism may have different configurations. It can be a check valve with a spring-loaded piston and/or one (or more) spring-loaded plastic, stainless steel, glass or rubber ball, with a rubber flap or flaps from another material, a magnetic valve, a flexible diaphragm, a combination of the above enumeration and/or any other unidirectional flow mechanism to ensure the water-tightness of the air jet J.

Also, the elbow fitting 28 can be replaced by a Tee fitting, or other. This configuration increases the flow of incoming air through the inlet of the hidden air jet 20, and consequently, the turbulence in the bathtub B.

It is noted that the shell 10 of the bathtub B, as seen in FIG. 1, comprises two composite layers, i.e. an inner visible layer 48 (for instance made of acrylic) and an underlying outer hidden layer 50 (for instance made of fibre glass).

In accordance with the present invention, there is provided a hollow decorative fastener F (see FIG. 1), generally in the form of a rivet. The fastener F is engaged in each of the holes 22 and 26 and accomplishes the following functions. First, it retains both the shell layers 48 and 50 together. Second, it conceals any sharp edge defined at the outlet of any of the holes 22 and 26, that is where the holes 22 and 26 open up into the inside cavity formed by the shell. This prevents a user located in the bathtub B from being possibly scratched, or other, by the visible edges of the holes 22 and 26. Finally, the fastener F provides an aesthetic finish around the holes 22 and 26 within the bathing cavity of the bathtub B.

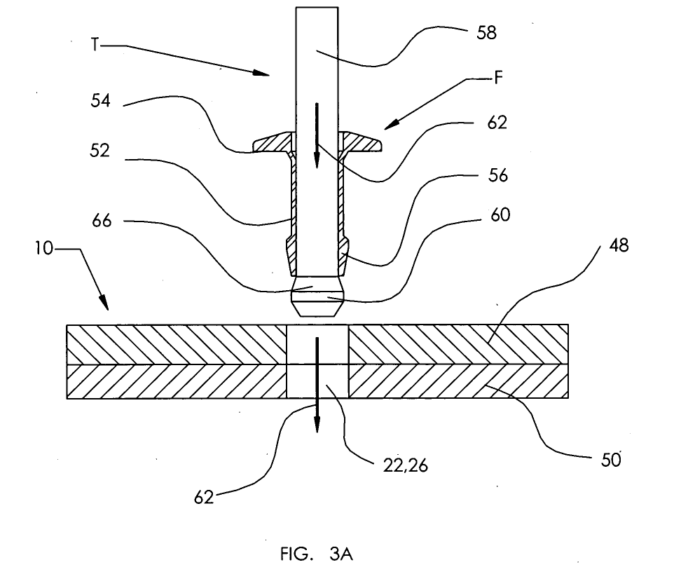

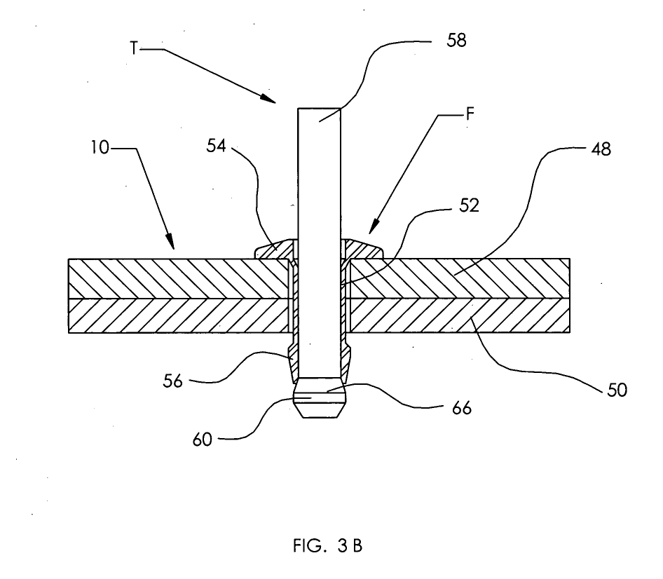

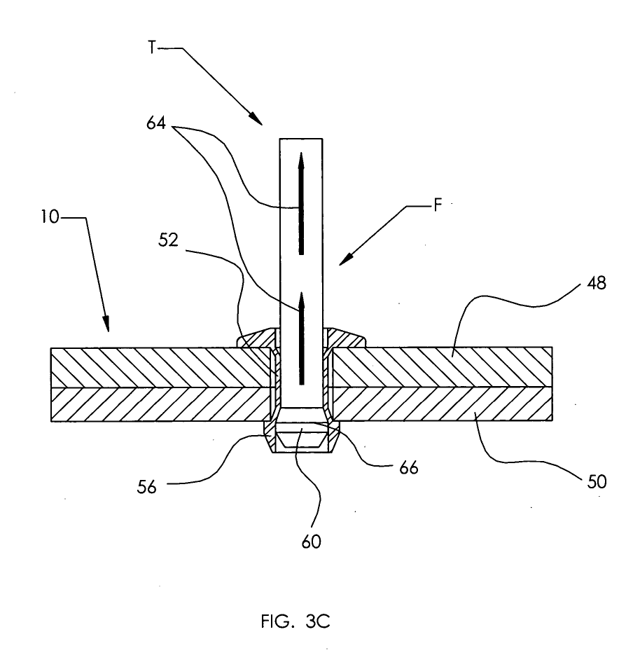

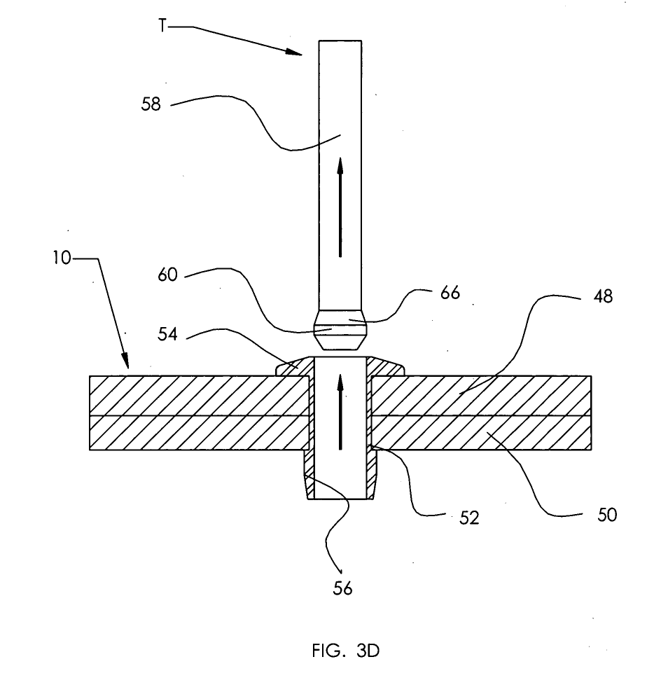

More particularly, the fastener F, when installed as in FIG. 1, includes a tubular member 52, a decorative hollow head 54 at the downstream visible end thereof, and an enlarged upstream hidden end 56, wherein the head 54 and the enlarged end 56 (best seen in FIG. 3d) retain the shell layers 48 and 50 in a contacting laminate relation thereby eliminating the possibility that a space is formed between the shell layers 48 and 50 adjacent the holes 22 and 26. To achieve this final position, the fastener F is deformed in a rivet-like way, as explained in more detail hereinafter.

The fastener F can be made of corrosion-proof metals, that can be polished, sanded, painted, plated or chemically treated to increase its finish, its mechanical properties, its resistance to corrosion, etc.

The fastener F can also be made of composite or plastic materials that can be deformed to compress the composite shell layers 48 and 50 in the same manner as the metallic fastener. Such a non-metallic fastener can be installed by heating, adhesion, welding, ultrasound, pressure fit, etc. The non-metallic fastener can also be polished, sanded, painted, plated or chemically treated to increase its finish, its mechanical properties, its resistance to corrosion, etc.

The fastener F is used on bathtubs such as the bathtub B illustrated in FIG. 2, which is provided with a bottom or side air injection system. The fastener F is used to solidify and/or beautify the holes 22 and 26 defined through the various juxtaposed composite layers 48 and 50 that form the shell 10 of the bathtub B. The fastener F provides a superior finish that prevents sharp edges defined on the upper layer 48 and around the holes 22 and 26 from injuring the user, and also improves the look in the bathtub B at these holes 22 and 26 by offering various finishes and colors.

As seen sequentially in FIGS. 3a to 3d, the fastener F is installed in the holes 22 and 26 as follows. The fastener F in its initial shape seen in FIG. 3a is mounted around a cylindrical carrier 58 of a tool T that includes an enlarged flared end 60 distally of the carrier 58 and that is larger than the distal end 56 of the fastener F to prevent the fastener F from falling off the tool T. The tool T and the fastener F carried thereby are then inserted through the hole 22/26, along arrows 62 in FIG. 3a, until they reach the position shown in FIG. 3b. The tool T is then withdrawn from the hole 22/26, i.e. along arrows 64 in FIG. 3c, whereby the enlarged end 60 of the tool T causes via its flare 66 the enlarged end 56 of the fastener F to deform (i.e. flatten while further enlarging) while then also causing the tubular member 52 of the fastener F to radially expand generally into contact with the shell walls defining the hole 22/26. As seen in FIG. 3d, the tool T is completely removed from the hole 22/26 and from the fastener F, with the latter being in its final installed position where it compresses the layers 48 and 50 of the shell 10 to thus avoid a possible delamination thereof and to avoid water infiltration in the shell 10 that could cause water leaks.

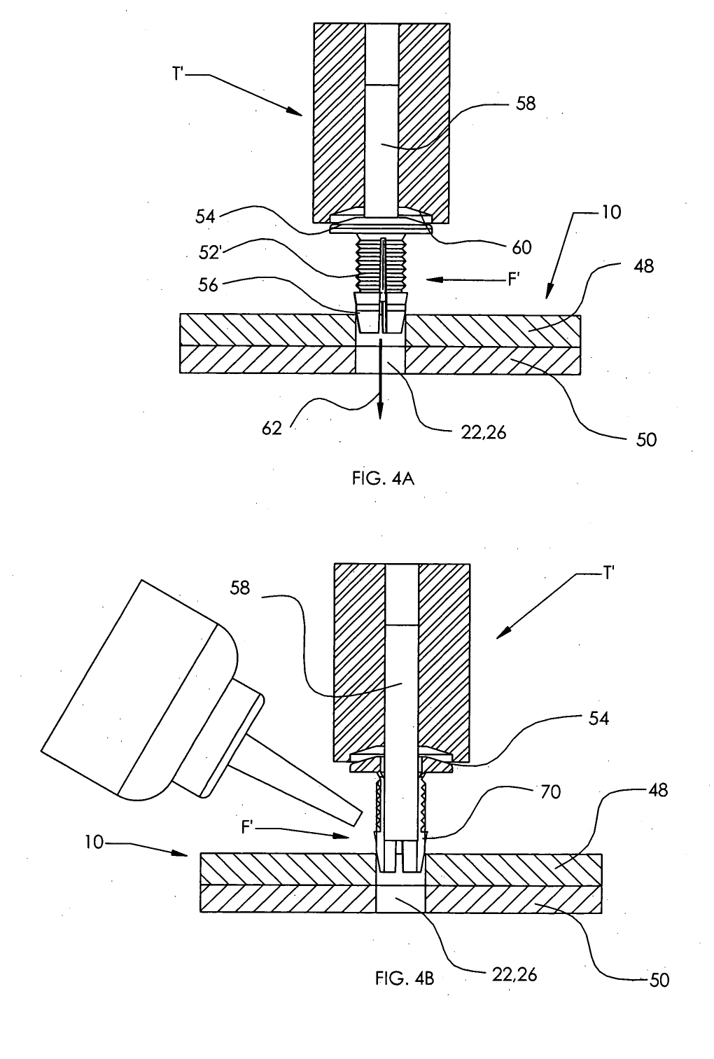

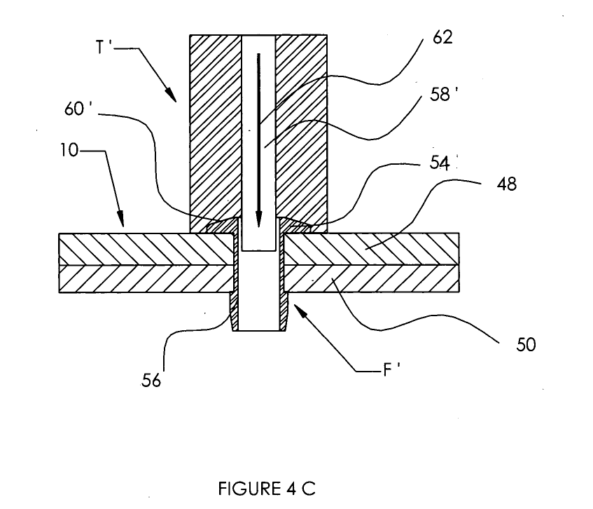

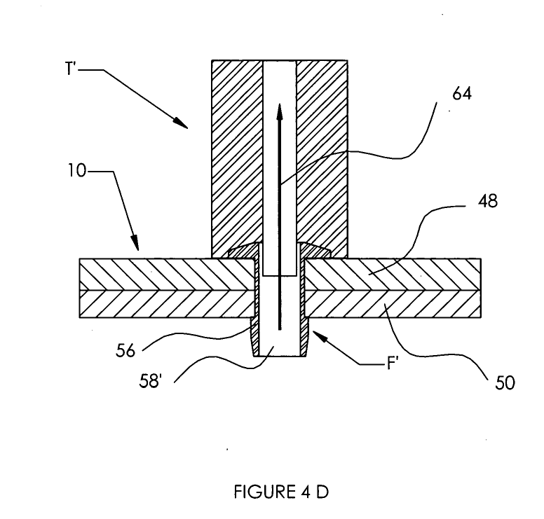

As an alternative to the sequence illustrated in FIGS. 3a to 3d, another sequence in accordance with a second embodiment of the present invention is illustrated in FIGS. 4a to 4d. More specifically, a variation to the fastener F is illustrated at F′. The fastener F′ is similar to the fastener F in that it has a decorative hollow head 54 and an enlarged upstream hidden end 56. The fastener F′ has a tubular member 52′ defining a pair of legs by a longitudinal slot.

A tool T′ is to be used for the installation of the fastener F′ to the shell 10 of the bathtub. The tool T′ has a carrier 58′ that can translate longitudinally with respect to a remainder of the tool T′. The tool T′ also has a cavity 60′, shaped so as to receive the head 54 of the fastener F′.

The fastener F′ in its initial shape seen in FIG. 4a is mounted around the cylindrical carrier 58′ of the tool T′. As seen in FIG. 4b, the hollow head 54 of the fastener F′ is received in the cavity 60′ of the tool T′, whereas the carrier 58′ is partially inserted into the tubular member 52′, as illustrated in FIG. 4b.

Prior to the insertion of the faster F′ into the holes 22, 26 of the shell 10, an adhesive 70 is optionally provided on an outer surface of the tubular member 52′. Thereafter, the fastener F′ may be inserted into the holes 22, 26 of the shell 10 in a first direction shown by arrows 62 of FIGS. 4a and 4c. The tool T′ exerts a pressure on the fastener F′ so as to insert the fastener F′ into holes 22, 26 of the shell 10 through the mating engagement of the hollow head 54 in the cavity 60′. The legs of the tubular member 52′ are inwardly deflected so as to enable the enlarged head 56 to pass through the holes 22, 26. Once the enlarged head emerges out of the holes 22, 26, the legs of the tubular member 52′ resiliently return to their initial position illustrated in FIGS. 4a and 4b. Therefore, at this position, the enlarged head overlaps the periphery of the holes 22, 26, and prevents the fastener F′ from being removed from the shell 10.

Still referring to FIG. 4c, the carrier 58′ is further reciprocated as shown by arrow 62 (and arrow 64 in FIG. 4d), with respect to a remainder of the tool T′, whereby it will exert a radial pressure on the legs of the tubular member 52′. This movement is optional, but ensures that the adhesive 70 is well spread and maintains the tubular member 52′ against the surface of the holes 22, 26.

Referring to FIG. 4d, the carrier 58′ is then translated in the direction illustrated by arrows 64, whereby the tool T′ can be removed and the fastener F′ is installed in the shell 10 of the bathtub.

The tools T and T′ can be manually operated, pneumatic, electric, or actuated using any other form of energy.

1. A fastener for use in air massage systems used with a bathtub having a shell having at least two layers, at least one hole being defined through the shell, comprising a hollow body adapted to extend through said hole and securing means provided for anchoring said fastener in the hole and for retaining together the layers of the shell.

2. The fastener as defined in claim 1, wherein said securing means comprise enlarged distal and proximal elements provided at opposed ends of said hollow body and adapted to be disposed against inner visible and outer hidden surfaces of the shell.

3. The fastener as defined in claim 2, wherein said proximal element includes a decorative head at least partly overlying the visible surface of the shell.

4. The fastener as defined in claim 2, wherein said hollow body comprises a tubular member and said proximal element includes a head provided at a proximal end of said tubular member, said distal element comprising a deformable element adapted to be displaced from an insertion position to an anchoring position, wherein during installation said deformable element in said insertion position is inserted through the hole and, with said tubular member extending in the hole, is then deformed to said anchoring position, whereby when said deformable element is in said anchoring position, said head at least partly overlies the visible surface of the shell.

5. The fastener as defined in claim 4, wherein in said anchoring position, said deformed element has transverse dimensions greater than those of the hole and is located against the hidden surface of the shell, whereby said tubular member is securely held in position in the hole by said head and by said deformed element provided at opposed ends of said tubular member with the layers of the shell being imprisoned between said head and said deformed element.

6. The fastener as defined in claim 4, wherein said head is provided with a decorative surface at least on a visible portion thereof, said visible portion being opposite a hidden portion of said head adapted to contact part of the visible surface of the shell.

7. The fastener as defined in claim 6, wherein said visible portion of said head is generally rounded so as to avoid forming any sharp edge when installed in the bathtub.

8. The fastener as defined in claim 4, wherein said tubular member has at least one longitudinal slot extending through said deformable element, so as to allow the displacement of the deformable element between the insertion position and the anchoring position.

9. A fastener in combination with a bathtub provided with an air massage system, said bathtub comprising a shell defining a bathing cavity and having at least two juxtaposed layers defining opposed visible and hidden surfaces of said shell, a plurality of holes being defined through said shell such that pressurised air delivered by said air massage system is conveyed through said holes from said hidden surface to said visible surface and into said cavity, said fastener being provided for each of said holes and comprising a hollow body extending through said hole and securing means provided for anchoring said fastener in said hole and for retaining together said layers of said shell.

10. The combination as defined in claim 9, wherein said securing means comprise enlarged distal and proximal elements provided at opposed ends of said hollow body and adapted to be disposed against inner visible and outer hidden surfaces of said shell.

11. The combination as defined in claim 10, wherein said proximal element includes a decorative head at least partly overlying said visible surface of said shell.

12. The combination as defined in claim 10, wherein said hollow body comprises a tubular member and said proximal element includes a head provided at a proximal end of said tubular member, said distal element comprising a deformable element adapted to displace from an insertion position to an anchoring position, wherein during installation said deformable element in said insertion position is inserted through said hole and, with said tubular member extending in said hole, is then deformed to said anchoring position, whereby when said deformable element is in said anchoring position, said head at least partly overlies said visible surface of said shell.

13. The combination as defined in claim 12, wherein in said anchoring position, said deformed element has transverse dimensions greater than those of said hole and is located against said hidden surface of said shell, whereby said tubular member is securely held in position in said hole by said head and by said deformed element provided at opposed ends of said tubular member with said layers of said shell being imprisoned between said head and said deformed element.

14. The combination as defined in claim 12, wherein said head is provided with a decorative surface at least on a visible portion thereof, said visible portion being opposite a hidden portion of said head adapted to contact part of said visible surface of said shell.

15. The combination as defined in claim 14, wherein said visible portion of said head is generally rounded thereby substantially smoothly merging with said visible surface of said bathtub.

16. The combination as defined in claim 10, further including a tool for installing said fastener to said shell, said tool including an elongated member adapted to extend into said fastener for inserting said fastener in said hole.

17. The combination as defined in claim 16, wherein said tool also includes an enlarged portion slidable through said hole and adapted when pulled out of said fastener located in the hole to cause said distal element of said fastener to enlarge radially to transverse dimensions that are greater than those of said hole.

18. The combination as defined in claim 17, wherein said enlarged portion of said tool is also adapted to radially expand said tubular member of said fastener within said hole.

19. A decorative device for use in air massage systems used with a bathtub having a shell and at least one hole defined through the shell, comprising a hollow body adapted to extend through said hole and a decorative member provided at a visible end of the decorative device and defining an opening in fluid communication with said hollow body such that pressurised air provided by the air massage system is conveyed through said decorative device and into the bathtub.

20. A method of installing a fastener into a hole of a shell of a bathtub provided with an air massage system, comprising the steps of:
(a) providing a hollow fastener;
(b) positioning said fastener on a tool;
(c) inserting said tool and said fastener carried thereby in said hole via a first direction;
(d) displacing said tool in a second direction different than said first direction such that said tool deforms said fastener and secures said fastener to said hole; and
(e) removing said tool from said hole.

21. The method as defined in claim 20, wherein said tool includes an elongated member adapted to extend into said fastener in steps (b) and (c) for inserting said fastener in said hole, and an enlarged portion slidable through said hole and adapted when pulled out, along said second direction in step (d), of said fastener located in the hole to cause a distal element of said fastener to enlarge radially to transverse dimensions that are greater than those of said hole.

22. The method as defined in claim 21, wherein said enlarged portion of said tool is also adapted, in step (d), to radially expand a tubular member of said fastener located within said hole.

23. The method as defined in claim 20, wherein said tool includes a fastener-receiving cavity for displacing said fastener in said first direction, and a carrier portion displaceable with respect to a remainder of the tool in said first and second directions to deform said fastener.

24. The method as defined in claim 20, further comprising a step of putting an adhesive on the fastener prior to step (c)
